(19) United States
(12) Patent Application Publication
(10) Pub. No.: US 2005/0107120 A1
(43) Pub. Date: May 19, 2005

(54) Mobile storage device with wireless bluetooth module attached thereto

(76) Inventor: Wen Hsiang Yueh, Hsin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/713,047

(22) Filed: Nov. 17, 2003

(51) Int. Cl. H04M 1/00; H04B 1/38

(52) U.S. Cl. 455/557

(57) ABSTRACT

A mobile storage device with a wireless Bluetooth module attached thereto has a memory control module connected with at least a memory for storage of digital data, an MP3 processing module connected to the memory control module and used to encode/decode a voice signal and an MP3 digital file, a detachable Bluetooth earphone module connected to the memory control module and the MP3 processing module and capable of accomplishing wireless transmission of digital data or voice signals with a remote device, and an electronic control switch connected to the MP3 processing module and the Bluetooth earphone module and also connected with at least an earphone and a microphone. Digital data or voice I/O signals transmitted by the Bluetooth earphone module or the MP3 processing module can be switched by the electronic control switch to accomplish wireless transmission function of the mobile storage device.

### FIELD OF THE INVENTION

The present invention relates to a mobile storage device with a wireless Bluetooth module attached thereto and, more particularly, to a small mobile storage device like a mobile disk, an MP3 walkman or a small digital voice recorder (DVR) with a wireless Bluetooth module attached thereto so that it can accomplish wireless transmission of data or voice with a mobile phone or a computer equipment.

### BACKGROUND OF THE INVENTION

Along with progress of the memory technology, many electronic products have become increasingly compact but can still store several megabytes of data. If expansion memory cards are added, the storage capacity can even be limitlessly expanded. Moreover, with multifunctional processing chips, electronic products have more and more functions. For instance, existent mobile disks use flash memories for storing considerable quantities of digital data and use USB interface for connection with computers.

If an MP3 processing chip is attached to a mobile disk, pop songs can be stored in the flash memory in the format of MP3 files. Through playback of the MP3 processing chip, the mobile disk becomes an MP3 walkman. If a microphone is further combined with the MP3 processing chip, the mobile disk becomes a small digital voice recorder capable of recording voices anytime, anywhere. Because the multifunctional mobile disk is small, it can be attached to another electronic product like a digital still camera, and an then make use of the memory card of the digital still camera to expand its storage capacity. Therefore, the digital still camera has all the functions of digital still camera, mobile disk, MP3 walkman, and digital voice recorder. Furthermore, the mobile disk can be attached to a mobile phone or a personal digital assistant (PDA) to expand the functions thereof further.

However, whatever the above multifunctional mobile storage device is connected to, a computer, a mobile phone, a digital still camera or a PDA, a transmission line like a USB transmission line is required. Moreover, the MP3 walkman also needs an earphone line connected the MP3 mobile disk for listening to music. Along with quick development of wireless transmission techniques, the above wired transmission methods can be replaced with a wireless transmission method like the Bluetooth technology for transmission of data and voice signals.

Nowadays, the Bluetooth technology is becoming increasingly popular. Many Bluetooth earphones are on the market, and they are usually accompany mobile phones for hands-free use. This kind of Bluetooth earphone has only a single function and can't be used for other applications. Accordingly, the present invention aims to integrate a wireless Bluetooth module in the above multifunctional mobile disk to replace the original wired transmission method with a wireless transmission way for transmission of digital data and voice signals to a Bluetooth earphone.

### SUMMARY OF THE INVENTION

An object of the present invention is to integrate a wireless Bluetooth module like a Bluetooth earphone into a multifunctional mobile storage device like a small mobile disk, an MP3 walkman or a small digital voice recorder to accomplish wireless connection with a remote device like a Bluetooth computer, a Bluetooth PDA or a Bluetooth MP3 walkman for wireless transmission of digital data, MP3 digital files or voice signals, thereby enhancing the wireless transmission function of the multifunction mobile storage device.

To achieve the above object, the present invention provides a mobile storage device with a wireless Bluetooth module attached thereto, which comprises a memory control module connected with at least a memory for storage of digital data, an MP3 processing module connected to the memory control module and used to encode/decode a voice signal and an MP3 digital file, a Bluetooth earphone module movably inserted into the storage device and connected to the memory control module and the MP3 processing module and capable of accomplishing wireless transmission of digital data or voice signals with a remote device using the same frequency and channel, and an electronic control switch connected to the MP3 processing module and the Bluetooth earphone module and also connected with at least an earphone and a microphone. Digital data or voice I/O signals transmitted by the Bluetooth earphone module or the MP3 processing module can be switched by the electronic control switch to achieve wireless transmission function of the mobile storage device.

Another object of the present invention is to provide the above mobile storage device with a wireless Bluetooth module attached thereto, in which the MP3 processing module can be use as an MP3 walkman or a recording device.

Yet another object of the present invention is to provide the above mobile storage device with a wireless Bluetooth module attached thereto. The remote device is also a Bluetooth module, which can be connected to a computer device, a mobile phone, a Bluetooth earphone, a PDA, or another mobile storage device to accomplish sharing and transmission of data stored in the memory.

Still another object of the present invention is to provide the above mobile storage device with a wireless Bluetooth module attached thereto, where when the remote device is connected to a mobile phone and the mobile phone has an incoming call, the electronic control switch can be controlled to switch the earphone and the microphone to be connected to the Bluetooth earphone module for accomplishing the effect of automatically answering the incoming call.

### BRIEF DESCRIPTION OF THE DRAWINGS

The various objects and advantages of the present invention will be more readily understood from the following detailed description when read in conjunction with the appended drawing, in which:

FIG. 1 is a perspective view and a wireless connection architecture diagram of the present invention;

FIG. 2 is a circuit block diagram of the present invention;

FIG. 3 is an application diagram showing wireless connection between the present invention and a mobile phone; and

FIG. 4 is an application diagram showing sharing of MP3 files of the present invention.

### DETAILED DESCRIPTION OF THE PREFERRED EMBODIMENTS

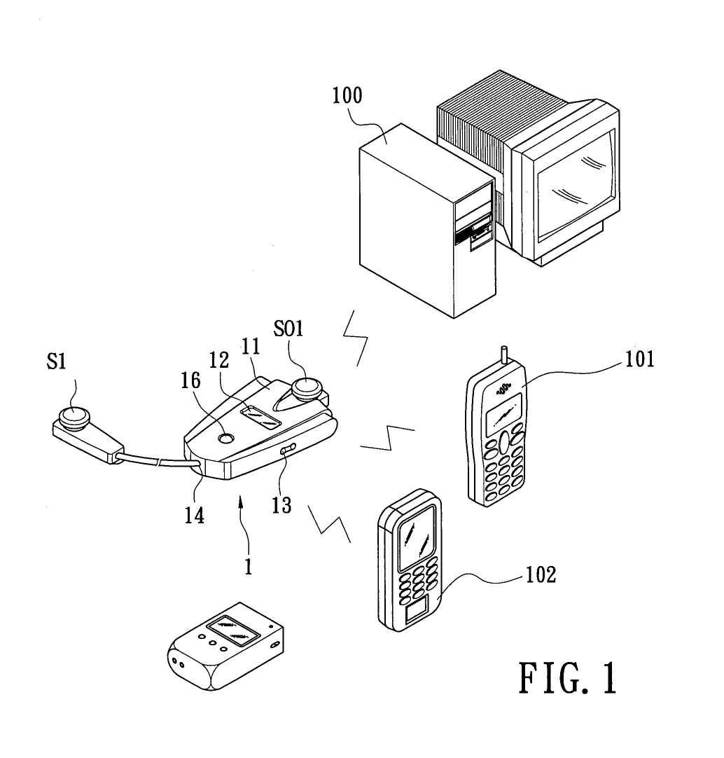

As shown in FIG. 1, the present invention provides a mobile storage device 1 with a wireless Bluetooth earphone module 10 attached thereto. The mobile storage device 1 can be a multifunctional flash memory disk having the functions of storage of digital data, an MP3 walkman or a recording device. The Bluetooth earphone module 10 can be for wireless transmission with at least a remote device. The remote device has also a wireless Bluetooth module (a remote device having a wireless Bluetooth module will be briefly termed as a remote Bluetooth module below), and can transmit digital or voice data using the same frequency and channel. The remote Bluetooth module can be a computer equipment 100, a mobile phone 101, a PDA 102, a Bluetooth earphone/microphone 103, or another mobile storage device.

The mobile storage device 1 of the present invention has an outer shell 11 with a display 12 and a plurality of function operation keys 13 arranged thereon. The display 12 can display the information (e.g., the directory and name) of the MP3 file being played. The function operation keys 13 can be used to select the function of the mobile storage device 1, such as, for example, MP3 playback function, voice recording function, memory function or transmission function, and can also be used to select the MP3 file to be played. The operation keys 13 can comprise a playback key, a stop key, a recording key and a volume key.

The outer shell 11 has an opening at the upper end thereof, and forms an accommodating groove. The Bluetooth earphone module 10 can be inserted into or detached from the accommodating groove. When the Bluetooth earphone module 10 is inserted into the accommodating groove, it can be connected with internal circuits of the mobile storage device to become a Bluetooth module of the mobile storage device 1 for accomplishing wireless transmission with a remote Bluetooth module. When the Bluetooth earphone module 10 is detached from the accommodating groove, it can be used as a common Bluetooth earphone. Besides, an earphone/microphone connection port 14 can be provided on the outer shell 11 for connection with an earphone 15 and a microphone 16. The microphone 16 is preferably installed inside the outer shell 11.

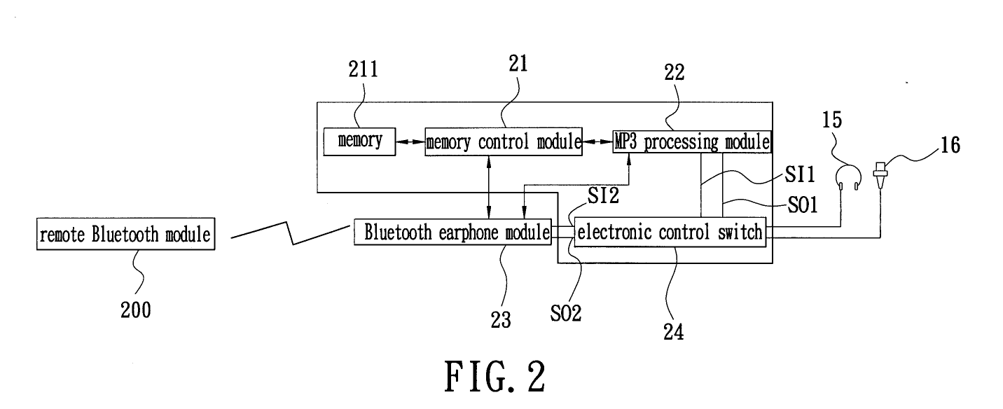

As shown in FIG. 2, the mobile storage device 1 of the present invention at least comprises a memory control module 21, an MP3 processing module 22, a Bluetooth earphone module 23 and an electronic control switch 24. The electronic control switch 24 is electrically connected to the earphone 15 and the microphone 16. The memory control module 21 is electrically connected with at least a memory 211 capable of storing considerable quantities of digital data. The memory 211 can be a flash memory. It is also feasible that the memory control module 211 is a memory card reader and the memory card 211 is a memory card movably inserted into the memory card reader for expansion or replacement of the memory card.

The MP3 processing module 22 is electrically connected to the memory control module 21, and has at least a first output signal line SO1 and a first input signal line SI1 both connected to the electronic control switch 24. The MP3 processing module 12 can be an MP3 decoding chip capable of decoding an MP3 digital file in the memory 211 into a voice signal outputted to the first output signal line SO1 and then to the earphone 15 through control of the electronic control switch 24. The electronic control switch 24 can also control the voice signal to be outputted to the Bluetooth earphone module 23 for wireless transmission to a remote Bluetooth module 200 like the Bluetooth earphone/microphone 103, thereby forming an MP3 playback device.

The MP3 processing module 22 is further electrically connected with the display 12 and the function operation keys 13. The display 12 can be used to display the information of an MP3 digital file to be displayed. The function operation keys 13 include the playback key, the stop key and the volume key, and can be used to control playback or stop of the MP3 digital file, or select the MP3 digital file to be played by the MP3 processing module 22, or control the volume.

The MP3 processing module 22 can also be an MP3 encoding chip capable of encoding the voice signal inputted from the microphone 16 via the first input signal line SI1 into the MP3 digital file stored into the memory 211 through control of the electronic control switch 24, thereby forming a voice recording device. Similarly, the electronic control switch 24 can control the Bluetooth earphone module 23 to send the voice signal of the remote Bluetooth module 200 like the Bluetooth earphone/microphone 103 to the MP3 processing module 22. The function operation keys 13 can further comprise the recording key for controlling the MP3 processing module 22 to record voice.

The Bluetooth earphone module 23 can be movably inserted into or detached from the memory control module 21 and the MP3 processing module 22. The Bluetooth earphone module 23 can accomplish wireless transmission of the digital data, the MP3 digital file or the voice signal with at least a remote Bluetooth module 200 using the same frequency and channel. The Bluetooth earphone module 23 has at least a second output signal line SO2 and a second input signal line SI2 both connected to the electronic control switch 24.

When the remote Bluetooth module 200 is the computer equipment 100, because the Bluetooth earphone module 23 is connected to the memory control module 21, the memory control module can accomplish wireless connection with the computer equipment 100 for direct transmission of digital data. This is an application of flash memory disk. The transmitted digital data can be an MP3 digital file directly stored in the memory 211 for expansion or replacement of the MP3 digital file.

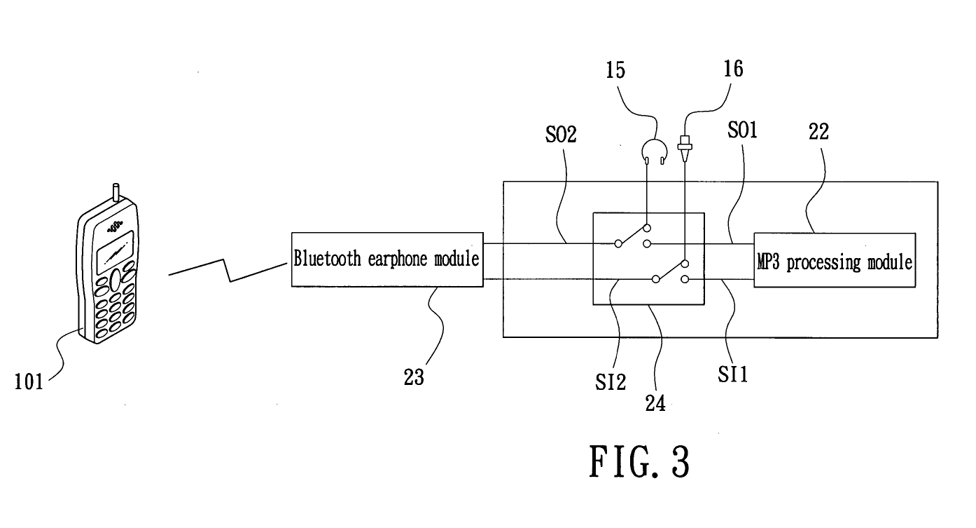

As shown in FIG. 3, when the remote Bluetooth module 200 is a mobile phone 101, the Bluetooth earphone module 23 can accomplish wireless connection with the mobile phone 101. The electronic control switch 24 can switch the second output signal line SO2 and the second input signal line SI2 to electrically connect the earphone/microphone 103 for answering the mobile phone 101.

If the present invention is used for the function of an MP3 walkman, the electronic control switch 24 will switch the first output signal line SO1 to electrically connect the earphone 15 so that one can listen to the MP3 digital file. When the mobile phone 101 has an incoming call, The electronic controls switch 24 can automatically switch the second output signal line SO2 and the second input signal line SI2 to electrically connect the earphone 15 and the microphone 16 for automatically answering the incoming call, respectively.

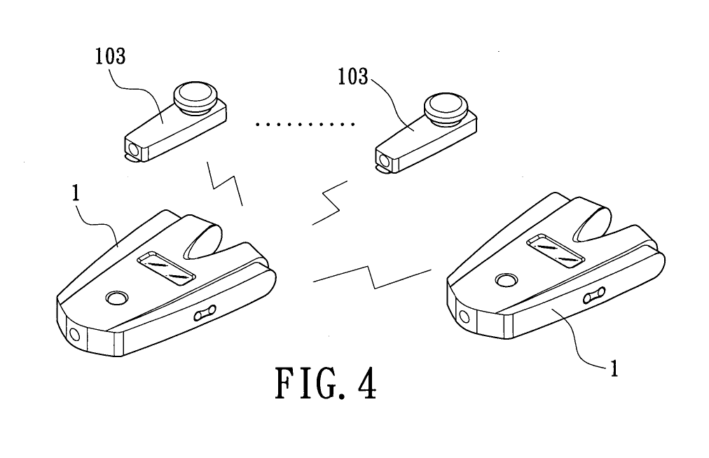

As shown in FIG. 4, when the present invention is used for the function of an MP3 walkman and the remote Bluetooth module 200 includes a plurality of Bluetooth earphones/microphones 103, all the Bluetooth earphone module 23 and the plurality of Bluetooth earphones/microphones 103 can use the same frequency and channel so that all the Bluetooth earphones/microphones 103 can be used for listening to the MP3 digital file being played. This application is preferably applied in a multi-user language learning situation. If the remote Bluetooth module 200 is another mobile storage device, sharing of MP3 digital files can be accomplished through wireless transmission. Of course, the Bluetooth earphone module 23 can switch different channels to avoid mutual interference.

To sum up, the electronic control switch 24 of the present invention can make use of function control of the function operation keys 13 to switch the Bluetooth earphone module 23 and the remote Bluetooth module 23 for wireless transmission of digital data, or switch the first output signal line SO1 or the second output signal line SO2 to electrically connect the earphone 15, or switch the first input signal line SI1 or the second input signal line SI2 to electrically connect the microphone 15.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A mobile storage device with a wireless Bluetooth module attached thereto comprising:
a memory control module electrically connected with at least a memory for storage of digital data;
an MP3 processing module electrically connected to said memory control module and having at least a first output signal line and a first input signal line and used to encode/decode data between a voice signal and an MP3 digital data;
a Bluetooth earphone module electrically connected to said memory control module and said MP3 processing module and capable of accomplishing wireless transmission of said digital data, said MP3 digital file or said voice signal with a remote device using the same frequency and channel, said Bluetooth earphone module having at least a second output signal line and a second input signal line; and
an electronic control switch electrically connected to said first output signal line, said second output signal line, said first input signal line and said second input signal line, said electronic control switch being also connected with at least an earphone and a microphone to switch said Bluetooth earphone module to transmit wirelessly digital data, switch said first output signal line or said second output signal line to connect electrically said earphone, or switch said first input signal line or said second input signal line to connect electrically said microphone.

2. The mobile storage device with a wireless Bluetooth module attached thereto as claimed in claim 1 further comprising an outer shell, a display electrically connected to said MP3 processing module being provided on said outer shell, said display being used to display information of the MP3 digital file being played by said MP3 processing module.

3. The mobile storage device with a wireless Bluetooth module attached thereto as claimed in claim 1, wherein said memory electrically connected with said memory control module is a flash memory.

4. The mobile storage device with a wireless Bluetooth module attached thereto as claimed in claim 1, wherein said memory control module is a memory card reader, said memory is a memory card, and said memory card is movably inserted into said memory card reader for expansion or replacement of said memory card.

5. The mobile storage device with a wireless Bluetooth module attached thereto as claimed in claim 1, wherein said MP3 processing module is an MP3 decoding chip capable of fetching an MP3 digital file from said memory and then decoding it into said voice signal outputted to said first output signal line, thereby forming an MP3 playback device.

6. The mobile storage device with a wireless Bluetooth module attached thereto as claimed in claim 5, wherein said MP3 processing module is further electrically connected with at least a playback key for controlling said MP3 processing module to play said MP3 digital file.

7. The mobile storage device with a wireless Bluetooth module attached thereto as claimed in claim 5, wherein said MP3 processing module is further electrically connected with a plurality of selection keys for selecting data in said MP3 digital file to be played by said MP3 processing module.

8. The mobile storage device with a wireless Bluetooth module attached thereto as claimed in claim 5, wherein said MP3 processing module is further electrically connected with a plurality of volume keys for controlling the playback volume of said MP3 digital file.

9. The mobile storage device with a wireless Bluetooth module attached thereto as claimed in claim 1, wherein said MP3 processing module is an MP3 encoding chip capable of inputting said voice signal via said first input signal line and then encoding said voice signal into an MP3 digital file stored in said memory, thereby forming a recording device.

10. The mobile storage device with a wireless Bluetooth module attached thereto as claimed in claim 9, wherein said MP3 processing module is further connected with a recording key for controlling said MP3 processing module to record voice.

11. The mobile storage device with a wireless Bluetooth module attached thereto as claimed in claim 1, wherein said Bluetooth earphone module is further connected to said memory control module, said remote Bluetooth module is connected to a computer equipment, and said memory control module accomplishes wireless transmission of said digital data with said computer equipment through said Bluetooth earphone module.

12. The mobile storage device with a wireless Bluetooth module attached thereto as claimed in claim 11, wherein the digital data transmitted between said memory control module and said computer equipment is an MP3 digital file, and said MP3 digital file is directly stored into said memory.

13. The mobile storage device with a wireless Bluetooth module attached thereto as claimed in claim 1, wherein said Bluetooth earphone module is further connected to said MP3 processing module, said remote Bluetooth module is electrically connected to a mobile phone, and said Bluetooth earphone module achieves wireless connection with said mobile phone to answer said mobile phone.

14. The mobile storage device with a wireless Bluetooth module attached thereto as claimed in claim 1, wherein said Bluetooth earphone module is electrically connected to said MP3 processing module, said remote Bluetooth module is a Bluetooth earphone, and said Bluetooth earphone mobile accomplishes wireless connection with said Bluetooth earphone to listen to said voice signal.

15. The mobile storage device with a wireless Bluetooth module attached thereto as claimed in claim 1, wherein said Bluetooth earphone module is electrically connected to said memory control module, said remote Bluetooth module is a remote mobile storage device, and said Bluetooth earphone mobile accomplishes wireless connection with said remote mobile storage device for transmission of digital data between them.

16. The mobile storage device with a wireless Bluetooth module attached thereto as claimed in claim 15, wherein the digital data transmitted between said Bluetooth earphone module and said remote mobile storage device is an MP3 digital file, and the MP3 digital file is directly stored into said memory.

17. The mobile storage device with a wireless Bluetooth module attached thereto as claimed in claim 1, wherein said electronic control switch further has a function key for switching functions of said electronic control switch.

18. The mobile storage device with a wireless Bluetooth module attached thereto as claimed in claim 1, wherein said electronic control switch is controlled by signals transmitted by said remote Bluetooth module to switch automatically functions of said electronic control switch.

19. The mobile storage device with a wireless Bluetooth module attached thereto as claimed in claim 18, wherein said remote Bluetooth module is connected to a mobile phone, and said remote Bluetooth module automatically controls said electronic control switch to switch said second output signal line to connect electrically said earphone and said second input signal line to electrically connect said microphone when said mobile phone has an incoming call.

20. The mobile storage device with a wireless Bluetooth module attached thereto as claimed in claim 19, wherein said remote Bluetooth module is connected to said mobile phone, and said remote Bluetooth module automatically controls said electronic control switch to switch said first output signal line to connect electrically said earphone and said first input signal line to electrically connect said microphone when the incoming call of said mobile phone is cut off.
